(19) United States
(12) Patent Application Publication
(10) Pub. No.: US 2025/0369520 A1
(43) Pub. Date: Dec. 4, 2025

(54) VALVE WITH CORROSION RESISTANT SLEEVE

(71) Applicant: Worthington Enterprises, Inc., Columbus, OH (US)

(72) Inventors: Chase EVANS, Marysville, OH (US); Edward Richard YOHO, Columbus, OH (US)

(21) Appl. No.: 19/188,248

(22) Filed: Apr. 24, 2025

Related U.S. Application Data
(60) Provisional application No. 63/655,146, filed on Jun. 3, 2024.

(51) Int. Cl. F16K 1/42; F16K 1/04; F16K 25/00; F17C 13/04

(52) U.S. Cl. CPC F16K 1/425; F16K 1/04; F16K 25/005; F17C 13/04; F17C 2205/0329; F17C 2205/0382

(57) ABSTRACT

A valve has a body having an inlet, an outlet, and chamber. The inlet is in fluid communication with the chamber and the chamber is in fluid communication with the outlet. The valve has a stem designed to be received in the chamber. The valve stem has a valve surface. A corrosion-resistant or nonreactive sleeve is inserted into the inlet. The sleeve has a first end and a second end opposite the first end and a bore that extends from the first end to the second end. When the sleeve is inserted into the inlet, the second end extends into the chamber and is configured to be deformed within the chamber to secure the sleeve in the inlet. The deformed second end defines a valve seat configured to engage the valve surface of the stem.

### RELATED APPLICATION DATA

This application claims priority to U.S. Provisional Patent Application No. 63/655,146 filed Jun. 3, 2024, which is incorporated herein by reference in its entirety.

### TECHNICAL FIELD

In general, the present application relates to valves used with pressure vessels or tanks, specifically corrosion-resistant valves.

### BACKGROUND

Valves are used with pressure vessels to selectively control the flow of fluids and gases into and out of the pressure vessel. Pressure vessels can hold a variety of materials at a pressure greater than ambient pressures. These materials include liquids like water, oil, solvents, chemicals, and fuels; gases like air, nitrogen, hydrogen, oxygen, and natural gas; and other various materials like refrigerants, steam, food and beverage products, among others. When installed on the pressure vessel, portions of the valve can be continually exposed to these materials or wetted by these materials even when the valve is closed. Prolonged exposure to these materials in the tank can cause the valve to corrode, oxidize, or degrade. Also, the material may have an adverse reaction to the valve material or coating, causing coagulation, discoloration etc. To prevent these issues, the valve body may be made of a corrosion-resistant or otherwise nonreactive material like stainless steel. On the other hand, valves that do not need corrosion resistance or reaction resistance can be made of less expensive materials like carbon steel.

### SUMMARY

In accordance with an embodiment of the present application, a valve comprises a body having an inlet, an outlet, and chamber, the inlet being in fluid communication with the chamber and the chamber being in fluid communication with the outlet. The valve comprises a stem designed to be received in the chamber and having a valve surface. The valve comprises a sleeve inserted into the inlet, the sleeve having a first end, a second end opposite the first end and a bore that extends from the first end to the second end. The sleeve is inserted into the inlet such that the second end extends into the chamber and is configured to be deformed within the chamber to secure the sleeve in the inlet and to create a valve seat configured to engage the valve surface of the stem.

In accordance with another embodiment of the present application, the body is made from a first material and the sleeve made from a second material.

In accordance with another embodiment of the present application, the sleeve is made of a corrosion-resistant or nonreactive material.

In accordance with another embodiment of the present application, the corrosion-resistant material is one of stainless steel, aluminum, nickel, ceramic, plastic, elastomers or polymer.

In accordance with another embodiment of the present application, the valve further comprises a stem designed to be received in the chamber and having a valve surface configured to engage the valve seat.

In accordance with another embodiment of the present application, the inlet further comprises a shoulder defining a first portion having a first diameter and a second portion having a second diameter, wherein the first diameter is greater than the second diameter.

In accordance with another embodiment of the present application, the sleeve further comprises a ledge between the first end and the second end configured to abut the shoulder in the inlet, such that a certain portion of the second end of the sleeve extends into the chamber.

In accordance with another embodiment of the present application, the sleeve is cylindrical.

In accordance with another embodiment of the present application, the inlet further comprises a flared surface that abuts the deformed crimp segment.

In accordance with another embodiment of the present application, the flared surface of the inlet is curved.

In accordance with another embodiment of the present application, the deformed crimp segment has a flare that abuts the flared surface of the inlet, and the flare of the sleeve has a diameter that is greater than the inlet.

In accordance with another embodiment of the present application, the bore of the sleeve has a first bore diameter at the first end of the sleeve and a second bore diameter at the second end of the sleeve.

In accordance with another embodiment of the present application, the first end of the sleeve is configured to attach to a pressure vessel.

In accordance with another embodiment of the present application, the first end of the sleeve comprises threads or barbs to engage components within a pressure vessel.

In accordance with another embodiment of the present application, a valve comprises a body having an inlet, an outlet, and chamber, the inlet being in fluid communication with the chamber and the chamber being in fluid communication with the outlet. The valve comprises a sleeve having a first end and a second end opposite the first end. The sleeve is inserted into the inlet from an opening in the chamber such that the second end engages a first opening in the inlet and the first end extends out of a second opening of the inlet and is configured to be deformed to secure the sleeve to the body.

In accordance with another embodiment of the present application, the body is made from a first material and the sleeve made from a second material.

In accordance with another embodiment of the present application, the second material is a corrosion-resistant or nonreactive material.

In accordance with another embodiment of the present application, wherein the first opening in the inlet has a flared surface and the second end of the sleeve has a flare that engages the flared surface of the first opening of the inlet, the flare of the sleeve having a diameter greater than a diameter of the opening in the inlet.

In accordance with another embodiment of the present application, the sleeve is secured to the body by crimping or welding or with a threaded connection.

In accordance with another embodiment of the present application, a method for manufacturing a valve comprises inserting a first end of a sleeve into an inlet of a valve body, such that the first end of the sleeve extends into a chamber of the valve body, inserting a deformation tool into a chamber opening of the valve body, the chamber opening being opposite of the inlet, and deforming the first end of the sleeve to secure the sleeve within the valve body and create a valve seat.

These and other objects of this application will be evident when viewed in light of the drawings, detailed description and appended claims.

### BRIEF DESCRIPTION OF THE DRAWINGS

Embodiments of the present application may take physical form in certain parts and arrangements of parts which will be described in detail in the specification and illustrated in the accompanying drawings which form a part hereof, and wherein:

FIG. 1 is a perspective view of an exemplary valve assembly.

FIG. 2 is a front view of the exemplary valve assembly.

FIG. 3 is a right side view of the exemplary valve assembly.

FIG. 4 is a bottom view of the exemplary valve assembly.

FIG. 5 is a right side cross-section view along line A-A showing an exemplary valve body.

FIG. 6 is a right side cross-section view along line A-A showing the exemplary valve assembly.

FIG. 7A is a right side cross-section view along line A-A showing the exemplary valve body including an uncrimped sleeve.

FIG. 7B is a right side cross-section view along line A-A showing the exemplary valve body including a crimped sleeve.

FIG. 8A is a perspective view of an exemplary uncrimped sleeve.

FIG. 8B is a front view of the exemplary uncrimped sleeve.

FIG. 8C is a right side cross-section view along line B-B showing the exemplary uncrimped sleeve.

FIG. 9A is a front view of the exemplary crimped sleeve.

FIG. 9B is a right side cross-section view along line C-C showing the exemplary crimped sleeve.

FIG. 10 illustrates a flow chart of a method for making the exemplary valve assembly.

FIG. 11A is a front view of a second exemplary crimped sleeve.

FIG. 11B is a right side cross-section view along line C-C showing the second exemplary crimped sleeve.

FIG. 11C is a right side cross-section view along line A-A showing the second exemplary valve body including a crimped sleeve.

### DETAILED DESCRIPTION

The present application describes embodiments related to a corrosion-resistant or nonreactive valve. The valve can be used with a pressure vessel configured to hold a variety of liquids and gases, like a DOT 39 cylinder. The valve has a sleeve inserted into the inlet of the valve body. The sleeve is made of a corrosion-resistant or otherwise nonreactive material like stainless steel, aluminum, nickel, plastic, polymer, an elastomer or some other suitable material. A sleeve made of the corrosion-resistant or nonreactive material may prevent the valve reacting with the contents held by the pressure vessel. It therefore may prevent corrosion, coagulation, discoloration, or other adverse effects caused by the contact between the valve and the contents of the pressure vessel. It will be appreciated that the corrosion-resistant or nonreactive sleeve material may be specifically chosen based on the intended contents of the pressure vessel so that the sleeve will not react with the contents of the pressure vessel. Once inserted in the valve body, a portion of the sleeve can be deformed while the portion is located within the valve body to secure the sleeve in the valve body. The deformed sleeve creates a valve seat configured to sealingly engage the valve stem. The sleeve provides corrosion resistance in the inlet portion of the valve body, which is exposed to the liquid or gas in the cylinder whether the valve is open or closed. With the sleeve providing corrosion-resistance to the inlet portion of the valve body, the valve body can be made of a less costly material, like carbon steel. Accordingly, the valve can be manufactured in a more cost-effective manner than existing valves.

With reference to the drawings, like reference numerals designate identical or corresponding parts throughout the several views. However, the inclusion of like elements in different views does not mean a given embodiment necessarily includes such elements or that all embodiments of the present application include such elements. The examples and figures are illustrative only and not meant to limit the present application, which is measured by the scope and spirit of the claims.

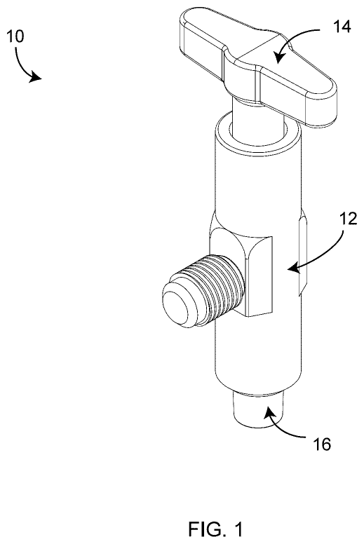

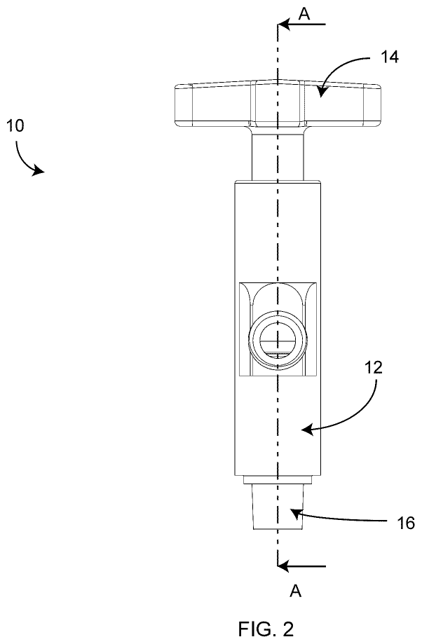

Turning now to FIGS. 1-5, a valve assembly 10 includes a valve body 12, a valve stem 14, and a sleeve 16. The valve assembly 10 may be configured to be installed on a pressure vessel capable of holding a variety of liquids or fluids. The pressure vessel can be made of steel, aluminum, titanium composites, or any other suitable material. The pressure vessel can be configured to hold liquids like water, oil, solvents, chemicals, and fuels; gases like air, nitrogen, hydrogen, oxygen, and natural gas; and other various materials like refrigerants, steam, food and beverage products, among others. As an example, the valve assembly 10 may be installed on a DOT 39 cylinder. The sleeve 16 is separate from the valve body 12 and can be inserted into the valve body 12, as described in further detail below. Accordingly, the valve body 12 and the sleeve 16 can be made of two different materials. The sleeve 16 may be made of a corrosion-resistant or nonreactive material, and the valve body 12 may be made of a less costly structural material.

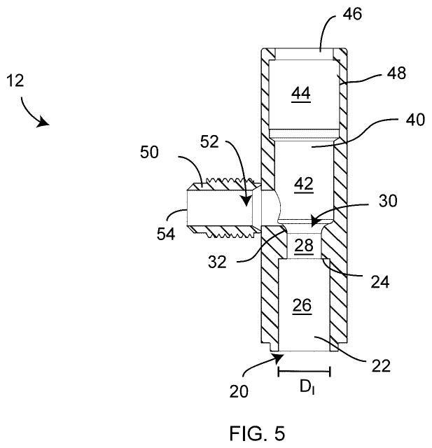

Turning to FIG. 5, a cross-section of the valve body 12 is shown. The valve body 12 has an inlet 20 that is configured to connect to the pressure vessel and receive fluid or gas from the pressure vessel. The inlet 20 has an inlet passageway 22 having a shoulder 24 that defines a first portion 26 of the inlet passageway 22 and a second portion 28 of the inlet passageway 22. The first portion 26 is proximate the inlet 20 of the valve body 12, and the second portion 28 is proximate a main chamber 40 of the valve body 12. The inlet passageway 22 may be cylindrical and therefore have an inlet diameter D_{I}. It should be appreciated that while D_{I} is depicted at the first portion in FIG. D_{I} may vary throughout the inlet passageway 22 as described herein. The inlet diameter D_{I} between the inlet 20 and the shoulder 24 may be greater than the inlet diameter D_{I} between the shoulder 24 and the main chamber 40. As such, the inlet diameter D_{I} of the first portion 26 is greater than the inlet diameter of the second portion 28. As illustrated in FIG. 5, inlet passageway 22 also has a flared portion 30 between the second portion 28 and the main chamber 40. In the flared portion 30, the inlet diameter D_{I} may gradually increase between the second portion 28 and the main chamber 40. As illustrated, the inlet diameter D_{I} may gradually increase such that an inner surface 32 of the flared portion 30 is curved between the second portion 28 and the main chamber 40. The curve of the inner surface 32 may be convex, as illustrated, or concave. Alternatively, the inlet diameter D_{I} may gradually increase such that an inner surface 32 of the flared portion 30 is linear or conical between the second portion 28 and the main chamber 40.

The main chamber 40 of the valve body 12 is in fluid communication with the inlet passageway 22. The main chamber 40 is generally cylindrical and configured to receive and engage the valve stem 14. The main chamber 40 has a first chamber 42 adjacent to flared portion 30 of the inlet passageway 22 and a second chamber 44 opposite the first chamber 42. The second chamber 44 has an opening 46 that is configured to receive the valve stem 14. The valve body 12 is arranged such that a central axis of the inlet passageway 22 and the central axis of the main chamber 40 are coaxial. Accordingly, the first portion 26, the second portion 28 and the flared portion 30 of the inlet passageway 22 and the first chamber 42 and second chamber 44 of the main chamber 40 form a through hole that extends a length of the valve body 12, where each respective section may have a different diameter. The internal surface 48 of the second chamber 44 may have internal threads that are configured to engage threads on the valve stem 14. Alternatively, a portion of the internal surface 48 of the second chamber 44 may have internal threads that are configured to engage threads on the valve stem 14. Additionally, portion of the first chamber 42 may also have internal threads configured to engage threads on the valve stem 14.

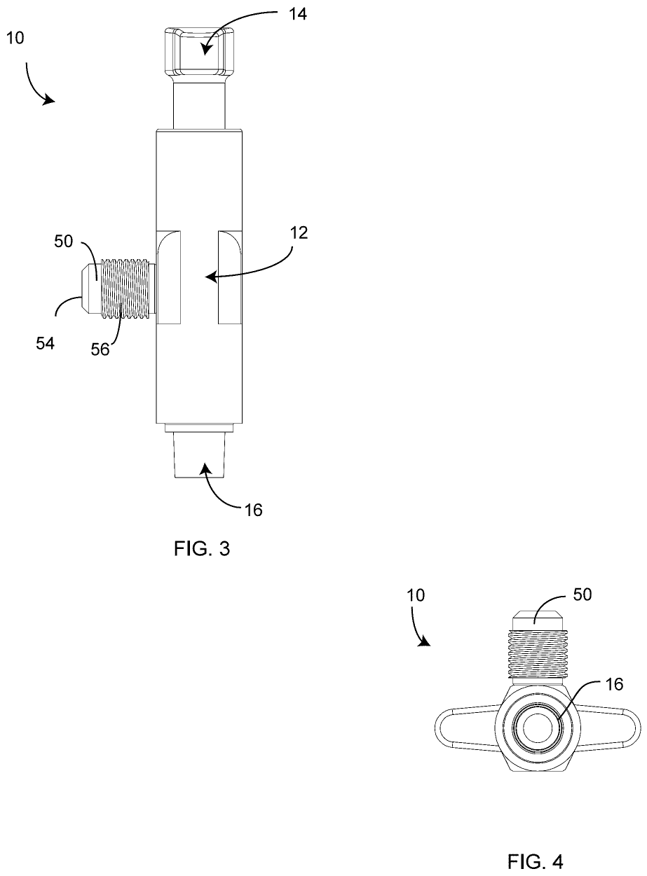

The valve body 12 further includes an outlet 50, which can be configured to allow fluids and gases to leave the valve assembly 10. The outlet 50 is secured to the side of the valve body 12 such that the valve body 12 is an angle valve. For instance, the outlet 50 may be secured to the side of the valve body 12 by welding. Alternatively, the outlet 50 may be integrally formed with the valve body 12. An internal outlet passageway 52 provides fluid communication between the first chamber 42 and an outlet opening 54. As illustrated, the outlet 50 may be positioned near the center of the valve body 12. It will be appreciated that the outlet 50 can be positioned anywhere on the valve body in accordance with sound engineering judgment so long as the outlet passageway 52 can provide fluid communication between the first chamber 42 and the outlet opening 54. The outlet passageway 52 may be substantially cylindrical. As shown in FIG. 3, the outlet 50 may have an external engagement surface 56 configured to engage a hose or tubing connected to a tool or apparatus using the fluid or gas within the pressure vessel. For instance, as illustrated, the engagement surface 56 may include threads to engage a threaded coupler on a hose. Alternatively, the engagement surface 56 may have a quick disconnect fitting or the engagement surface 56 may be barbed to retain tubing connected to the valve.

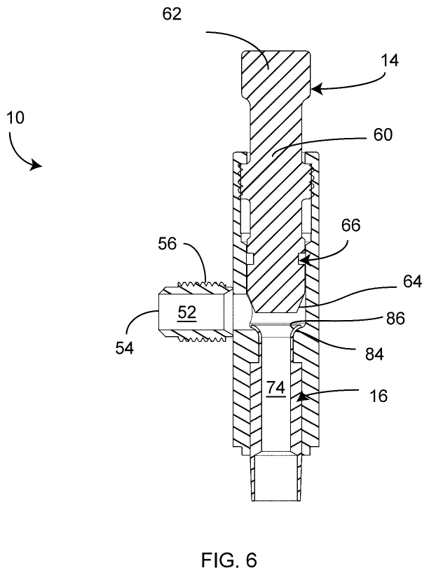

As shown in FIG. 6, the valve assembly 10 may further include a valve stem 14, at least a portion of which is configured to be received within the main chamber 40. The valve stem 14 may have a body 60 that is substantially cylindrical. The body 60 may have a handle 62 at its first end and a valve surface 64 at a second end opposite the first end. As will be described in further detail below, the valve surface 64 is configured to be selectively engaged with a valve seat. A portion of the body 60 may include threads configured to engage the internal threads in the second chamber 44. Through the engagement of the threads on the body 60 and the internal threads in the second chamber 44, the valve stem 14 can be rotated using the handle 62 to move the valve stem 14 in and out of the valve body 12, which selectively obstructs the outlet passageway 52, or provides fluid access to the outlet passageway 52 from the main chamber 40. As illustrated, the handle 62 may be T-shaped. Alternatively, the handle 62 may be circular, ovular, triangular, or any other suitable shape. The handle 62 may be ridged, knurled, or coated with an abrasive or non-slip material, like rubber or silicone, to provide a gripping surface. The body 60 of the valve stem 14 may also include at least one groove 66 configured to receive a seal between the body 60 and the first chamber 42. The seal may prevent any liquid or gas from moving from the first chamber 42 into the second chamber 44 and out of the valve body 12 through the opening 46. The seal may be an O-ring made of resilient material like rubber, silicone, or any other suitable material. Alternatively, the seal may be a packing seal, gland seal, a gasket (or multiple gaskets), or any other suitable seal. The valve stem 14 can be made of metal, composites, plastics, polymers, or any other suitable material. For instance, the valve stem can be glass-filled nylon, aluminum, brass, copper, or nickel. Further, the valve stem 14 may be made be made of a corrosion-resistant or material that does not react with the material in the pressure vessel.

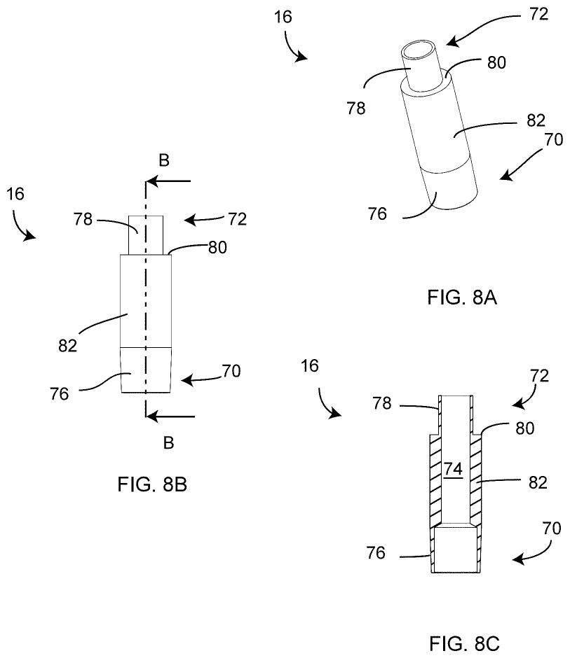

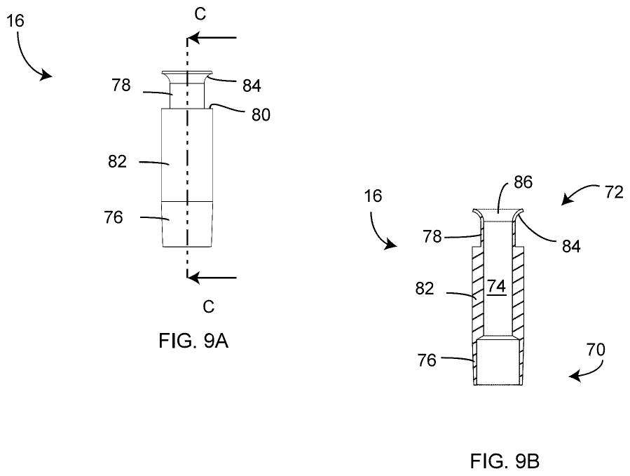

Turning now to FIGS. 6-9B, the sleeve 16 will be described. The sleeve 16 may be substantially cylindrical and configured to be received within the inlet passageway 22 of the valve body 12. The sleeve 16 has a first end 70, a second end 72 opposite the first end 70, and a bore 74 that extends there through. The sleeve 16 may vary in diameter between the first end 70 and the second end 72, thereby defining segments of the sleeve 16. As illustrated in FIG. 8C, at the first end 70 the outer diameter of the sleeve 16 may gradually taper and increase defining an attachment segment 76 of the sleeve. At the second end 72 of the sleeve 16, a crimp segment 78 is defined where the outer diameter is abruptly decreased. This abrupt step down in the outer diameter forms a ledge 80 that is configured to abut the shoulder 24 in the inlet passageway 22 when the sleeve is 16 inserted into the inlet passageway 22. A center segment 82, having a constant diameter, is defined between the ledge 80 and the end of the attachment segment 76. The diameter of the bore 74 may also vary. As illustrated, the diameter of the bore 74 in the attachment segment 76 is greater than the diameter of the bore 74 of the center segment 82 which is equal to the diameter of the bore 74 in the crimp segment 78. As such, the thickness of the wall of the sleeve 16 may vary along its length. It will be appreciated that both the diameter of the sleeve 16 and the diameter of the bore 74 in different segments of the sleeve 16 may be selected according to sound engineering judgement to meet performance goals of the valve.

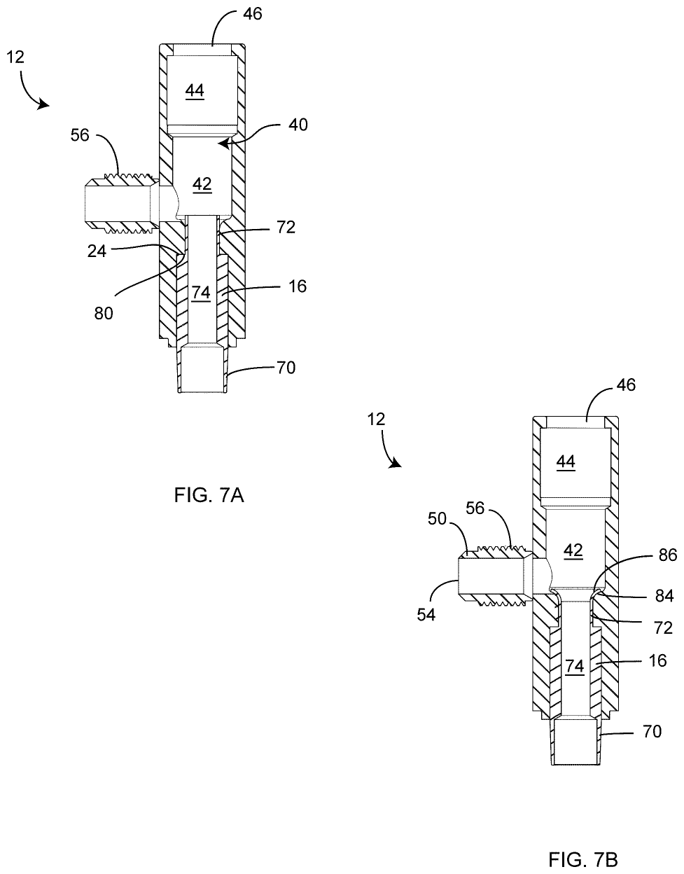

As illustrated in FIG. 7A, the second end 72 of the sleeve 16 can be inserted into the valve body 12 until the ledge 80 of the sleeve abuts the shoulder 24 of the inlet passageway 22. When the sleeve 16 is fully inserted into the valve body 12, the crimp segment 78 is received in the second portion 28 and the flared portion 30 and partially extends in to the first chamber 42 of the main chamber 40. Further, the center segment 82 is adjacent to the first portion 26 of the inlet passageway 22. The attachment segment 76 of the sleeve 16 extends out of the inlet 20 of the valve body 12 and, depending on the application of the cylinder, is configured to engage the interior of the cylinder or any compartments, features, or sections within the cylinder. For instance, the attachment segment 76 may include threads, barbs, or may be smooth. In one embodiment, the attachment segment 76 may engage or be integrally formed with a diptube that extends to the bottom of the pressure vessel. The diptube could be made of the same corrosion-resistant or nonreactive material as the sleeve 16. Alternatively, the diptube may be made of a different corrosion-resistant material, nonreactive material, other suitable material than the sleeve 16.

Turning to FIG. 7B, to secure the sleeve 16 in the valve body 12, the crimp segment 78 of the sleeve 16 can be deformed outward such that the diameter of the portion of the crimp segment 78 that extends into the first chamber 42 is greater than the diameter of the portion of the crimp segment 78 that remains in the second portion 28 of the inlet passageway 22. When the crimp segment 78 is deformed outward, a flare 84 is formed on the sleeve 16 that abuts the flared portion 30 of the inlet passageway 22. A valve seat 86 is formed on the inner surface of the flare 84 that is configured to sealingly engage the valve surface 64 of the valve stem 14. The flare 84 creates a mechanical interference with the flared portion 30 of the inlet passageway 22 that retains the sleeve 16 in the valve body 12. Further, the flare 84 creates a seal between the sleeve 16 and the main chamber 40, which prevents any liquid from entering the inlet passageway 22. Other methods of retention could be used in combination or as an alternative to the deforming the crimp segment 78 of the sleeve 16 to form the flare 84. For instance, the sleeve 16 could be held in the valve body 12 with an alternative mechanical interference fit like a friction fit or press fit. Further, a mechanical fastener like a nut, bolt, rivet, screw, or pin or a chemical fastener like an adhesive, cement, or epoxy could be used to further secure the sleeve 16 in the valve body 12. The sleeve 16 and the valve body 12 may also be welded together. Further, the sleeve 16 may be secured to the valve body 12 with a threaded connection. For instance, the external surface of the sleeve 16 may have external threads that are configured to engage corresponding internal threads on the inlet passageway 22 in the valve body 12.

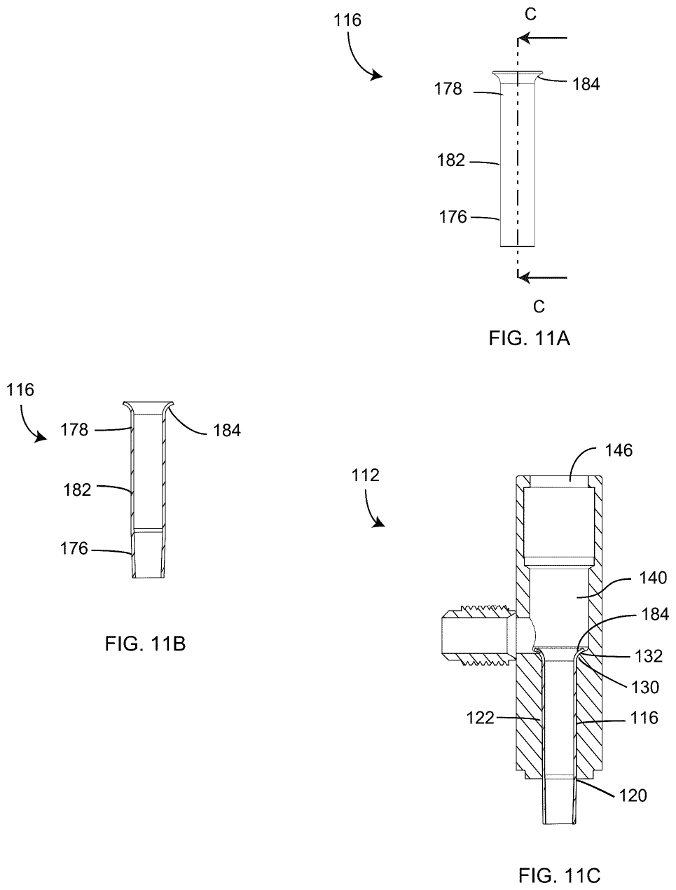

In an alternative implementation illustrated in FIGS. 11A-11C, the sleeve 116 may be configured to be dropped into the valve body 112 through the opening 146 in the main chamber 140. In this configuration, the flare 184 of the sleeve 116 may be formed before being inserted into the valve body 112. Further, the diameter of the sleeve 116 at the crimp segment 178 and the center segment 182 may be equal to form a substantially smooth and consistent outer surface of the sleeve 116. The sleeve 116 is inserted into the opening 46 in the main chamber until the flare 84 abuts the inner surface 132 of the flared portion 130 of the inlet passageway 122 and the attachment segment 176 of the sleeve 116 extends out of the inlet 120. To secure the sleeve 16 in the valve body 112, the attachment segment may be deformed to create a mechanical interference between the sleeve 116 and the valve body 112. Alternatively, the sleeve 116 and the valve body 112 may be welded together. Further, any of the mechanical or chemical fasteners listed above can also be used for this alternative implementation. As described above, the sleeve 116 can also be secured with a threaded connection between the sleeve 116 and the valve body 112.

A valve assembly 10 including the described sleeve 16 provides a cost-effective corrosion-resistant valve. The sleeve 16 may be made of a corrosion-resistant or nonreactive material like stainless steel, aluminum, nickel, ceramic, or any other suitable material. In an alternative embodiment, the sleeve could be made of a plastic, polymer, or elastomer. The plastic, polymer, or elastomer could be heated up and deformed to create the flare 84. The valve body 12 can be made of a less costly material like carbon steel, nickel-plated carbon steel, brass, or any other suitable material. As such, a majority of the valve assembly 10 is made from a less costly material, and the portion of the valve assembly that is consistently exposed to the contents of the pressure vessel (the inlet passageway 22) is protected by the sleeve 16. Manufacturing the cylindrical sleeve 16 in the corrosion-resistant or nonreactive material is cheaper and easier than making the entire valve body in the corrosion-resistant or nonreactive material based on the amount of material used and geometry of the respective parts.

To allow for fluid or gas to flow through the valve, the valve assembly 10 may have an open position and a closed position. The valve stem 14 is selectively positionable within the main chamber 40 to provide the open position and the closed position of the valve assembly 10. As previously described, a user can rotate the handle 62 of the valve stem 14 to move the valve stem 14 in and out of the valve body 12 by the engagement of the threads on the valve stem 14 and the threads in the second chamber 44 of the valve body 12. In the closed position, the valve surface 64 is sealingly engaged with the valve seat 86 to prevent fluid or gases from flowing through the valve assembly 10. In the open position, the valve stem 14 is at least partially moved out of the valve body 12, and the valve surface 64 is disengaged from the valve seat 86 to allow fluid or gas to flow through the valve assembly 10. In the open position, the contents of the pressure vessel can flow through the bore 74 of the sleeve 16 into the first chamber 42 of the main chamber 40 and through the outlet passageway 52 to the outlet opening 54.

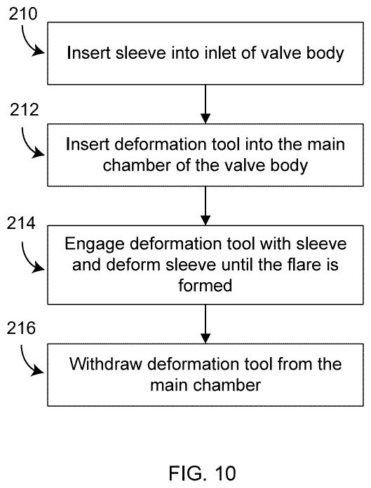

Turning to FIG. 10, a method for manufacturing the valve assembly is further disclosed.

At 210, the sleeve 16 may be inserted into the inlet 20 of the valve body 12 until the ledge 80 of the sleeve abuts the shoulder 24 in the inlet passageway 22. Depending on the dimensions of the parts, the sleeve 16 may be simply inserted into the valve body 12 by hand. If there is an interference fit between the sleeve 16 and the valve body 12, a tool like a manual or automatic press may be used to assist seating the sleeve 16 in the valve body 12. At 212, to deform or crimp the crimp segment 78 of the sleeve 16, a deformation tool or die may be inserted into the main chamber 40 of the valve body 12 through the opening 46. Alternatively, the deformation tool or die may be inserted into the main chamber 40 of the valve body 12 through the first end 70 of the sleeve 16 and through the bore 74 of the sleeve 16. At 214, a surface of the deformation tool can engage the crimp segment 78 and be manually, mechanically, or automatically pressed toward the inlet 20 of the valve body 12 to deform the crimp segment 78. The crimp segment 78 can be deformed until the flare 84 is formed and abuts the inner surface 32 of the flared portion 30 of the inlet passageway 22. This forms a seal between the sleeve 16 and the first chamber 42 of the main chamber 40 that prevents wetting of the inlet passageway 22 of the valve body 12. The deformation of the crimp segment 78 can be permanent. At 216, once the flare 84 is formed and the sleeve 16 is secured in the valve body 12, the deformation tool can be withdrawn from the opening 46 in the valve body 12. The valve stem 14 can be inserted into the opening 46 and rotated so the threads on the valve stem 14 engages the threads in the second chamber 44. The valve stem 14 can be rotated until the valve surface 64 engages the valve seat 86 and the valve assembly 10 is in the closed position.

The aforementioned systems, components, (e.g., valve body, valve stem, sleeve), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the apparatus, systems and methods discussed above, these embodiments are intended to be exemplary and are not intended to limit the applicability of these embodiments to only those discussions set forth herein.

The above examples are merely illustrative of several possible embodiments of various aspects of the present application, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the application. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to embodiments of the valve assembly, including the best mode, and also to enable one of ordinary skill in the art to practice the disclosure of the application, including making and using any devices or systems and performing any incorporated methods. The patentable scope of the application is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the disclosure of the application has been described for purposes of illustrating the best mode known to the applicant at the time and enable one of ordinary skill in the art to practice the disclosure of the application, including making and using devices or systems and performing incorporated methods. The examples are illustrative only and not meant to limit the application, as measured by the scope and merit of the claims. The disclosure of the application has been described with reference to exemplary and alternate embodiments. Obviously, modifications and alterations will occur to others upon the reading and understanding of the specification. It is intended to include all such modifications and alterations insofar as they come within the scope of the appended claims or the equivalents thereof. The patentable scope of the application is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A valve, comprising:
a body having an inlet, an outlet, and chamber, the inlet being in fluid communication with the chamber and the chamber being in fluid communication with the outlet; and
a sleeve having a first end, a second end opposite the first end, and a bore that extends from the first end to the second end,
wherein the sleeve is disposed within the inlet such that the second end partially extends into the chamber and the second end of the sleeve has a crimp segment configured to be deformed within the chamber to secure the sleeve in the inlet and to create a valve seat.

2. The valve of claim 1, wherein the body is made from a first material and the sleeve is made from a second material.

3. The valve of claim 1, wherein the sleeve is made of a corrosion-resistant or nonreactive material.

4. The valve of claim 3, wherein the corrosion-resistant material is one of stainless steel, aluminum, nickel, plastic, ceramic, elastomer, or polymer.

5. The valve of claim 1, further comprising a stem designed to be received in the chamber and having a valve surface configured to engage the valve seat.

6. The valve of claim 1, the inlet further comprising a shoulder defining a first portion having a first diameter and a second portion having a second diameter, wherein the first diameter is greater than the second diameter.

7. The valve of claim 6, the sleeve further comprising a ledge between the first end and the second end configured to abut the shoulder in the inlet, such that a certain portion of the second end of the sleeve extends into the chamber.

8. The valve of claim 1, wherein the sleeve is cylindrical.

9. The valve of claim 1, wherein the inlet further comprises a flared surface that abuts the deformed crimp segment.

10. The valve of claim 9, wherein the flared surface of the inlet is curved.

11. The valve of claim 9, wherein the deformed crimp segment has a flare that abuts the flared surface of the inlet, the flare of the sleeve has a diameter that is greater than at least a portion of the inlet.

12. The valve of claim 1, wherein the bore of the sleeve has a first bore diameter at the first end of the sleeve and a second bore diameter at the second end of the sleeve.

13. The valve of claim 1, wherein the first end of the sleeve is configured to engage with a pressure vessel.

14. The valve of claim 13, wherein the first end of the sleeve comprises threads or barbs to engage one or more components within the pressure vessel.

15. A valve, comprising:
a body having an inlet, an outlet, and chamber, the inlet being in fluid communication with the chamber and the chamber being in fluid communication with the outlet; and
a sleeve having a first end and a second end opposite the first end,
wherein the sleeve is configured to be inserted into the inlet from an opening in the chamber such that the second end engages a first opening in the inlet and the first end extends out of a second opening of the inlet and is configured to be secured to the body.

16. The valve of claim 15, wherein the body is made from a first material and the sleeve made from a second material.

17. The valve of claim 16, wherein the second material is a corrosion-resistant or nonreactive material.

18. The valve of claim 15, wherein the first opening in the inlet has a flared surface and the second end of the sleeve has a flare that engages the flared surface of the first opening of the inlet, the flare of the sleeve having a diameter greater than a diameter of the first opening in the inlet.

19. The valve of claim 15, wherein the sleeve is secured to the body by crimping or welding.

20. A method for manufacturing a valve, comprising:
inserting a first end of a sleeve into an inlet of a valve body, such that the first end of the sleeve extends into a chamber of the valve body;
inserting a deformation tool into a chamber opening of the valve body, the chamber opening being opposite of the inlet; and
deforming the first end of the sleeve to secure the sleeve within the valve body and create a valve seat.
